(19) United States
(12) Patent Application Publication
(10) Pub. No.: US 2007/0007185 A1
(43) Pub. Date: Jan. 11, 2007

(54) Recycling feed apparatus for thinner

(75) Inventors: Yuji Tanaka, Kitakyushu-shi (JP); Norihiro Takasaki, Kitakyushu-shi (JP)

Correspondence Address: NIXON & VANDERHYE, PC, 901 NORTH GLEBE ROAD, 11TH FLOOR, ARLINGTON, VA, 22203, US

(73) Assignee: MITSUBISHI CHEMICAL ENGINEERING CORPORATION, Tokyo (JP)

(21) Appl. No.: 11/492,209

(22) Filed: Jul. 25, 2006

(30) Foreign Application Priority Data
Jan. 31, 2005 (JP) 2005-022586

(51) Int. Cl. B01D 21/30

(52) U.S. Cl. 210/96.1; 210/96.2; 210/149; 210/167.01; 118/603; 118/666; 118/689

(57) ABSTRACT

The present invention relates to a recycling feed apparatus for thinner which serves for purifying a used thinner recovered from a coating treatment process to control a concentration of impurities in the thinner within an adequate range, and recycling the thinner to the coating treatment process, wherein the concentration of the impurities can be detected at a high accuracy, thereby not only enabling feed of the thinner whose concentration is fully controlled but also enhancing a recovery rate of the thinner. The recycling feed apparatus for thinner according to the present invention comprises a feed storage tank (1) for storing a thinner to be fed, a recovered solution purification mechanism (2) for purifying the used thinner and feeding the purified thinner to the feed storage tank (1), a raw solution feed mechanism (3) for feeding a thinner raw solution to the feed storage tank (1), and a concentration meter (5) for detecting a concentration of impurities in the purified thinner on the basis of at least one characteristic value selected from an ultrasonic propagation speed, an electromagnetic conductivity and an absorbance as measured, wherein feed of the purified thinner and the thinner raw solution can be controlled on the basis of the concentration detected by the concentration meter (5).

### BACKGROUND OF THE INVENTION

The present invention relates to a recycling feed apparatus for thinner, and more particularly, to a recycling feed apparatus for thinner which is capable of purifying a used thinner recovered from a coating treatment process for photoresist, etc., upon production of liquid crystal substrates or printed boards to control a concentration of impurities in the thinner such as pigments and resins to a predetermined value, and recycling the thus purified thinner to the coating treatment process.

In the coating treatment process for applying a photoresist on a substrate upon production of liquid crystal substrates or printed boards, unnecessary photoresist adhered to ends of these substrates or an inside of a spin coater has been removed by using, as a cleaning agent, various thinners, e.g., a solvent such as polypropylene glycol monomethyl ether acetate (PGMEA) and propylene glycol monomethyl ether (PGME). Recently, the amount of the thinner used in the above process tends to be increased owing to increase in size of the substrates or progress of the process. Therefore, it is desirable to recycle the used thinner to the coating treatment process from the standpoints of low costs and prevention of environmental problems.

As the thinner recycling method, there are known a distillation method, an evaporative separation method, etc. For example, there has been proposed the “organic solvent recovering apparatus” for recovering an organic solvent from a mixed solution of a photoresist and an organic solvent (thinner) which is generated during a coating treatment process for the photoresist, which apparatus includes an evaporation container for vaporizing and separating the organic solvent from the mixed solution of the photoresist and the organic solvent by disposing a heating conduit through which a heating medium heated by a heater is circulated, around a body portion of the apparatus, and a liquefaction container for liquefying the gaseous organic solvent separated in the evaporation container by disposing a cooling conduit through which a coolant cooled by a refrigerator is circulated, around a body portion of the apparatus (refer to Japanese Patent Application Laid-open (KOKAI) No. 2002-23388).

Meanwhile, in the coating treatment process used upon production of liquid crystal substrates or printed boards, in order to enhance a yield of these products, it has been demanded to develop a higher-grade thinner. If such a higher-grade thinner is used in the above thinner recycling method utilizing evaporative separation thereof, it is possible to recover and recycle a thinner containing a less amount of impurities. However, the recycling method utilizing the evaporative separation still fails to fully achieve the low costs and solve the environmental problems, because the amount of the thinner to be subjected to disposal treatment is relatively large as compared to the amount of the thinner recovered.

### SUMMARY OF THE INVENTION

The present invention has been made in view of the above conventional problems. An object of the present invention is to provide a recycling feed apparatus for thinner for purifying a used thinner recovered from a coating treatment process for photoresist, etc., upon production of liquid crystal substrates or printed boards to control a concentration of impurities such as pigments and resins in the thinner to a predetermined value, and recycling the thus purified thinner to the coating treatment process, which is capable of detecting the concentration of impurities in the thinner at a high accuracy, feeding the thinner having a fully well-controlled concentration to the coating treatment process, enhancing a recovery rate of the thinner, and further reducing costs required for the process.

In the present invention, in order to enhance a recovery rate of the thinner, the recovered thinner is purified by separating and removing the impurities such as pigments and resins therefrom by using a separation membrane. Further, in order to control a concentration of the impurities in the thinner to a suitable level upon feeding the thus purified thinner to the coating treatment process, there is used a concentration meter of such a type capable of measuring at least one characteristic value selected from an ultrasonic propagation speed, an electromagnetic conductivity and an absorbance which are univocally determined according to temperature and concentrations of respective components and free from the change in measurement accuracy due to fluctuation of the concentration, thereby enabling the concentration of the impurities in the thinner to be detected at a high accuracy.

Thus, in accordance with the present invention, there is provided a recycling feed apparatus for thinner in which a thinner containing impurities is recovered from a coating treatment process, purified and then recycled to the coating treatment process, said apparatus comprising:

a feed storage tank for storing the thinner to be fed to the coating treatment process,

a recovered solution purification mechanism for purifying the recovered thinner, controlling a temperature of the thinner to a predetermined value, and feeding the thus temperature-controlled thinner to the feed storage tank,

a raw solution feed mechanism for feeding a fresh thinner raw solution to the feed storage tank and

a first concentration meter for detecting a concentration of the impurities in the thinner controlled to the predetermined temperature which is fed by the recovered solution purification mechanism;

said recovered solution purification mechanism being provided with a separation membrane for separating and removing the impurities from the recovered thinner;

said first concentration meter being capable of measuring at least one characteristic value selected from an ultrasonic propagation speed through the thinner, an electromagnetic conductivity or absorbance of the thinner, and detecting the concentration of the impurities in the thinner on the basis of a relationship between the concentration of the impurities and the characteristic value which is previously prepared by measuring these values at a predetermined temperature and a predetermined concentration, and

feed of the purified thinner by the recovered solution purification mechanism and feed of the thinner raw solution by the raw solution feed mechanism being controlled on the basis of the concentration detected by the first concentration meter.

### EFFECT OF THE INVENTION

According to the recycling feed apparatus for thinner according to the present invention, since impurities contained in the thinner to be circulated is removed using a separation membrane in a recovered solution purification mechanism, it is possible to enhance a recovery rate of the thinner and further reduce the costs required for production processes. Besides, by measuring at least one characteristic value selected from an ultrasonic propagation speed, an electromagnetic conductivity and an absorbance using a specific concentration meter, it is possible to detect the concentration of the impurities in the thinner at a high accuracy. Therefore, the thinner which is well-controlled in concentration of the impurities therein can be supplied to the coating treatment process.

### BRIEF DESCRIPTION OF DRAWING

FIG. 1 is a flow diagram showing essential components of a recycling feed apparatus for thinner according to the present invention.

### DETAILED DESCRIPTION OF THE INVENTION

The recycling feed apparatus for thinner according to a preferred embodiment of the present invention is explained by referring to the accompanying drawing.

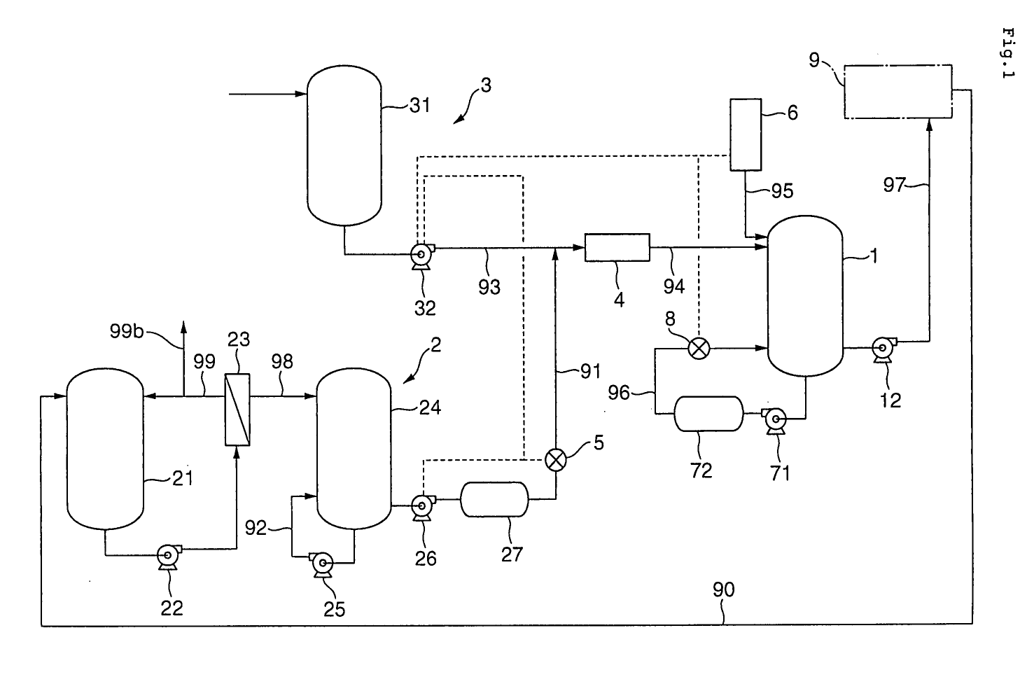

In FIG. 1, there is shown a flow diagram of essential components of the recycling feed apparatus for thinner according to the present invention. In the following description of the preferred embodiment of the present invention, the recycling feed apparatus for thinner is referred to merely as a “recycling feed apparatus”.

The recycling feed apparatus of the present invention is used for feeding a thinner to a coating treatment process in which a photoresist is applied to a substrate upon production of liquid crystal substrates or printed boards, or a coating treatment process in which various coating films are formed using a coater, etc., and has functions for recovering a thinner containing impurities such as pigments and resins from the above coating treatment process and purifying the thinner, and recycling the thus purified thinner to the coating treatment process.

Examples of the thinner used in the present invention may include propylene glycol monomethyl ether acetate (PGMEA), propylene glycol monomethyl ether (PGME), n-butyl alcohol (NBA), benzene, toluene and ethyl acetate. These thinners may be used alone or in the form of a solution containing a mixture thereof.

As shown in FIG. 1, the recycling feed apparatus of the present invention is mainly constituted from a feed storage tank (1) for storing a thinner to be fed to a coating treatment process (9); a recovered solution purification mechanism (2) for purifying the recovered thinner, controlling a temperature of the thinner to a predetermined value, and feeding the thus-controlled thinner to the feed storage tank (1); a raw solution feed mechanism (3) for feeding a fresh thinner raw solution to the feed storage tank (1); and a concentration meter (5) for detecting a concentration of impurities such as pigments and resins contained in the thinner controlled to the predetermined temperature which is to be fed to the feed storage tank (1) by the recovered solution purification mechanism (2) (hereinafter referred to the “first concentration meter”).

The feed storage tank (1) serves as a buffer tank for controlling a concentration of the impurities in the thinner within an adequate range and feeding the thus concentration-controlled thinner to the coating treatment process (9) according to requirements. For example, the feed storage tank (1) may be constituted from a corrosion-resistant container having an inner capacity of about 5 to 5000 L. The feed storage tank (1) may be provided with a thinner stirring means including a pump (71) and a circulating flow path (96) in order to control and maintain the thinner to be stored therein at a uniform concentration. The stirring means of such a circulation type can be reduced in amount of particles generated and prevent the thinner from being contaminated as compared to those stirring devices such as screws disposed inside of the tank. The thinner stored in the feed storage tank (1) is fed through a pump (12) and a flow path (97) to the coating treatment process (9).

The recovered solution purification mechanism (2) has a purification function for separating and removing the impurities such as pigments and resins from the thinner in order to enhance a recovery rate of the thinner, as well as a function for controlling a temperature of the thinner to a predetermined value in order to accurately measure the concentration of the impurities in the thinner by the first concentration meter (5). More specifically, the recovered solution purification mechanism (2) includes a recovered solution storage tank (21) for temporarily storing the used thinner recovered, a separation membrane (23) for separating and removing the impurities from the recovered thinner, a purified solution storage tank (24) for temporarily storing the thinner purified by filtration using the separation membrane, a temperature control means for controlling a temperature of the thus purified thinner to a predetermined value, etc.

The recovered solution storage tank (21) may be constituted, for example, from a corrosion-resistant container having an inner capacity of about 50 to 5000 L. The above coating treatment process (9) and the recovered solution storage tank (21) are connected to each other through a recovery flow path (90), and the recovered solution storage tank (21) is arranged so as to directly receive the used thinner discharged from the coating treatment process (9). The used thinner stored in the recovered solution storage tank (21) is fed to the separation membrane (23) by means of a pump (22).

As the separation membrane (23), there may be usually used an UF membrane (ultrafiltration membrane) or an NF membrane (nano-filtration membrane). These separation membranes may be constituted of an ordinary organic membrane, and especially preferably a ceramic membrane. The ceramic membrane may be made of a ceramic material containing SiO₂, Al₂O₃, TiO₂, CaO, MgO, ZrO₂, Si₃N₄, etc., as a main component, and usually has a tubular structure or a monolith structure. The pore diameter of the ceramic membrane may be variously designed depending upon baking conditions, etc. The ceramic membrane exhibits an excellent solvent resistance and is also capable of withstanding a high-temperature treatment. As a result, the ceramic membrane can be regenerated and repeatedly reused by washing with chemicals and then, if required, baking. Therefore, the ceramic membrane is more advantageous as compared to the organic membrane.

In the recycling feed apparatus of the present invention, in view of the practical cost balance between facility costs or operation costs and a recovery rate of the thinner, the impurities such as pigments and resins which are contained in the recovered used thinner are partially removed by the separation membrane (23). The reason why a whole amount of the impurities such as pigments and resins are not removed upon separation and purification of the thinner, is as follows. That is, when the separation performance (removal percentage) of resin components is increased, a flow rate of the thinner passing through the membrane is reduced. Therefore, in order to ensure a necessary amount of the thinner circulated, the use of a large-size separation membrane is required. On the other hand, when the separation performance (removal percentage) of the resin components is decreased, the flow rate of the thinner passing through the membrane is increased, but the concentration of the impurities such as pigments and resins contained in the thinner circulated is increased. As a result, the amount of the used thinner discharged out of the system is increased, resulting in decrease in recovery rate (recycling percentage) of the thinner.

In the present invention, in the case where the concentration of the impurities contained in the used thinner (thinner to be purified) is 50 to 5000 ppm, the removal percentage of the impurities such as pigments and resins by the separation membrane (23) may be adjusted to about 10 to 95%. As the separation membrane satisfying the removal percentage in the above-specified range, there may be used the ceramic membrane having a fractional molecular weight of 1000 to 50000. Usually, as the UF membrane, there may be used those membranes having a fractional molecular weight of about 5000 to 50000, and as the NF membrane, there may be used those membranes having a fractional molecular weight of about 500 to 5000.

On a penetration side of the separation membrane (23), there is provided a flow path (98) connected to the purified solution storage tank (24), so that the thinner separated and purified by the separation membrane (23) is fed to the purified solution storage tank (24) through the flow path (98). On the other hand, on a non-penetration side of the separation membrane (23), there is provided a flow path (99) connected to the recovered solution storage tank (21), so that the thinner unpassed through the separation membrane (23) which contains the impurities such as pigments and resins at a high concentration is circulated back to the recovered solution storage tank (21) through the flow path (99).

The purified solution storage tank (24) may be constituted of, for example, a corrosion-resistant container having an inner capacity of about 50 to 5000 L similarly to the above recovered solution storage tank (21). The purified solution storage tank (24) is provided with a stirring means constituted from a pump (25) and a circulating flow path (92) in order to equalize a concentration of the used thinner received therein. The above stirring means of a circulation type can be reduced in amount of particles generated and prevent the thinner from being contaminated similarly to that used in the feed storage tank (1).

The temperature control means of the recovered solution purification mechanism (2) is provided for accurately measuring the concentration of the impurities such as pigments and resins in the thinner by the below-mentioned first concentration meter (5), and is constituted of, for example, a constant temperature vessel (27) disposed on a rear stage side of the purified solution storage tank (24). More specifically, the thinner recovered and purified in the purified solution storage tank (24) is fed to the constant temperature vessel (27) by means of a pump (26), and controlled to a predetermined temperature (e.g., 25° C.) therein. The thus temperature-controlled thinner is ready for feeding to the side of the feed storage tank (1) through a flow path (91). The flow path (91) is connected, for example, to a flow path (93) extending from a raw solution storage tank (31) of the below-mentioned raw solution feed mechanism (3) to the side of the feed storage tank (1).

The recycling feed apparatus of the present invention is arranged such that when the thinner recovered from the coating treatment process (9) and then purified is recycled to the coating treatment process (9), a fresh thinner raw solution can be added, if required, to the thus separated and purified thinner by the raw solution feed mechanism (3) in order to maintain the concentration of the impurities in the thinner at a predetermined value or lower.

The raw solution feed mechanism (3) is mainly constituted from a raw solution storage tank (31) for storing a thinner raw solution, and a pump (32) and the flow path (93) for feeding the thinner stored in the raw solution storage tank (31) to the side of the feed storage tank (1). The raw solution storage tank (31) is constituted of, for example, a corrosion-resistant container having an inner capacity of about 50 to 5000 L similarly to the purified solution storage tank (24). The thinner raw solution in the raw solution storage tank (31) is fed to the feed storage tank (1) through the pump (32), the flow path (93), a mixer (4) and a flow path (94). The mixer (4) serves for mixing the regenerated thinner fed through the flow path (91) with a fresh thinner raw solution, and is constituted of a stirrer provided therein with a built-in type stationary screw.

Meanwhile, the feed storage tank (1), the recovered solution storage tank (21), the purified solution storage tank (24), the constant temperature vessel (27), the raw solution storage tank (31) and the below-mentioned constant temperature vessel (72) are sealed with a inert gas such as nitrogen in order to prevent the thinner or thinner raw solution from coming into contact with air. Further, in the recycling feed apparatus of the present invention, in order to maintain an amount of the solution in the system at a constant level, a mechanism for discharging an excess amount of the thinner containing the impurities such as pigments and resins at a high concentration out of the system upon feeding the fresh thinner raw solution may be provided at appropriate positions. For example, in a flow path (99) extending from the non-penetration side of the separation membrane (23) to the recovered solution storage tank (21), there may be provided a purge flow path (99b) branched therefrom which has a control valve (not shown).

The first concentration meter (5) is disposed, for example, in the flow path (91) connected to the rear side of the constant temperature vessel (27) in order to detect the concentration of the impurities such as pigments and resins in the purified thinner controlled to the predetermined temperature which is to be fed to the feed storage tank (1). In the recycling feed apparatus of the present invention, there is used the specific concentration meter in order to detect the concentration of the impurities in the thinner at a high accuracy without being adversely influenced by the change in concentration of the impurities such as pigments and resins in the thinner. More specifically, as the above first concentration meter, there may be used such a concentration meter capable of measuring at least one characteristic value selected from an ultrasonic propagation speed through the thinner, and an electromagnetic conductivity or absorbance of the thinner, and detecting the concentration of the impurities such as pigments and resins on the basis of a relationship (matrix) between the concentration and the characteristic value which is previously prepared by measuring these values at a predetermined temperature and at a predetermined concentration (concentration of the impurities).

The above concentration meter serves for measuring at least one parameter selected from an ultrasonic propagation speed, an electromagnetic conductivity and an absorbance in a solution maintained at a predetermined temperature, thereby enabling measurement of a concentration of a single component contained therein or simultaneous measurement of concentrations of a plurality of components contained therein, at real time. That is, the concentration meter performs the measurement on the basis of such a principle that the ultrasonic propagation speed, electromagnetic conductivity and absorbance in the solution is univocally determined by the concentration of the respective components if the solution is maintained at a constant temperature, and is mainly constituted of an ultrasonic converter, an ultrasonic oscillator, an electromagnetic conductivity converter, an electromagnetic conductivity oscillator and a microprocessor conducting a given operation.

When applying the above concentration meter to the measurement of the concentration of impurities in the thinner, the ultrasonic propagation speed, electromagnetic conductivity and absorbance are previously measured every combination of temperature of the thinner and concentration of the impurities in the thinner to prepare the relationship therebetween as a matrix. More specifically, when the matrix is written to the microprocessor, the concentration of the impurities such as pigments and resins in the thinner can be accurately estimated by operation of the microprocessor from the measured characteristic value on the basis of the matrix. As the concentration meter, there may be used, for example, a concentration meter “FUD-1 Model-51” manufactured by Fuji Kogyo Co., Ltd., which is known as a fluid concentration meter.

In the recycling feed apparatus of the present invention, on the basis of the concentration detected by the above first concentration meter (5), the amount of the purified thinner fed by the recovered solution purification mechanism (2) as well as the amount of the thinner raw solution fed by the raw solution feed mechanism (3) can be controlled so as to adjust the concentration of the impurities such as pigments and resins contained therein within an adequate range. The feed of the purified thinner and the thinner raw solution is controlled by the below-mentioned controller (not shown). As a result, the increase in concentration of the impurities such as pigments and resins due to recycling of the thinner can be effectively inhibited and compensated, so that the concentration of the impurities in the thinner stored in the feed storage tank (1) can be always controlled within an adequate range.

Meanwhile, in order to control the concentration of the impurities such as pigments and resins in the thinner fed to the coating treatment process (1) at a still higher accuracy, it is preferred that the concentration of the impurities in the thinner stored in the feed storage tank (1) is directly detected. Also, when the concentration of the impurities such as pigments and resins in the purified thinner fed by the recovered solution purification mechanism (2) exceeds an allowable level, the thinner raw solution is fed by the raw solution feed mechanism (3) so as to adjust the concentration of the impurities such as pigments and resins to a suitable range. However, even in such a case, the concentration of the impurities in the thinner stored in the feed storage tank (1) might sometimes exceed a target value depending upon the amount of the thinner raw solution fed.

To solve the above problem, the recycling feed apparatus of the present invention is provided with a diluting thinner feed mechanism for feeding a diluting thinner to the feed storage tank (1). In addition, in order to finally conduct fine adjustment of the concentration of the impurities in the thinner stored in the feed storage tank (1), there are provided a second temperature control means for controlling a temperature of the thinner in the feed storage tank (1) to a predetermined value, and a second concentration meter (8) for detecting the concentration of the impurities such as pigments and resins in the thinner controlled to the predetermined temperature which is stored in the feed storage tank (1). In the recycling feed apparatus of the present invention, on the basis of the concentration of the impurities detected by the second concentration meter (8), the amount of the thinner raw solution fed by the raw solution feed mechanism (3) as well as the amount of the diluting thinner fed by the diluting thinner feed mechanism can be controlled by the below-mentioned controller.

The diluting thinner feed mechanism is usually constituted of a diluting thinner tank (6) from which the diluting thinner can be fed to the feed storage tank (1) through a flow path (95). The second temperature control means is disposed for measuring the concentration of the impurities in the thinner at a still higher accuracy. For example, the temperature control means may be constituted from a constant temperature vessel (72) disposed in the course of a circulating flow path (96) serving as a stirring means for the thinner. More specifically, in the feed storage tank (1), the thinner located in the course of the circulating flow path is allowed to temporarily stay in the constant temperature vessel (72) so as to maintain a temperature of the thinner at a constant value. As the second concentration meter (8), there may be used a concentration meter of the same type as the first concentration meter (5).

Upon controlling feed of the thinner raw solution and the diluting thinner, the amount of the thinner raw solution fed from the raw solution feed mechanism (3) as well as the amount of the diluting thinner fed from the diluting thinner feed mechanism (i.e., a diluting thinner tank (6)) are cascade-controlled on the basis of the concentration detected by the second concentration meter (8). Upon such a cascade control, there may be used, for example, a so-called asymptotic method described in Japanese Patent Application Laid-open (KOKAI) No. 10-180076 (1998) entitled “Method and apparatus for diluting acid or alkali raw solutions”.

More specifically, in the case where the concentration of the impurities in the feed storage tank (1) is controlled by the asymptotic method, upon controlling the increased concentration of the impurities in the thinner stored in the feed storage tank (1) to the predetermined concentration range by adding the thinner raw solution (or the diluting thinner) thereto, a concentration measuring step of measuring the concentration of the impurities in the thinner by the second concentration meter (8) and a preparation step of computing a deficient amount of the thinner raw solution (or the amount of the diluting thinner to be added) on the basis of the difference between the concentration value actually measured in the concentration measuring step and a target concentration value, and feeding 85 to 99% and preferably 92 to 98% of the thus calculated deficient amount (amount to be added) are executed, and further the concentration measuring step and the preparation step are repeated until the measured concentration value falls within a range of the target concentration value. As a result, it is possible to control the concentration of the impurities in the thinner stored in the feed storage tank (1) at a still higher accuracy.

Further, according to the preferred embodiment of the present invention, in order to control the concentration of the impurities in the thinner stored in the feed storage tank (1) at a still higher accuracy, the constant temperature vessel (72) as the second temperature control means is provided therein with a temperature sensor (not shown) for detecting the temperature of the thinner. Also, the second concentration meter (8) has a function for conducting a correction operation on the basis of the temperature of the thinner detected by the temperature sensor upon detecting the concentration of the impurities such as pigments and resins in the feed storage tank (1).

More specifically, in the above concentration meter, by previously preparing the relationship as a matrix between the concentration of the impurities in the thinner and at least one characteristic value selected from an ultrasonic propagation speed, an electromagnetic conductivity and an absorbance by measured these characteristic values every combination with the concentration of the impurities such as pigments and resins and under a plurality of temperature conditions, the concentration of the impurities in the thinner stored in the feed storage tank (1) can be more accurately estimated by computing operation on the basis of the matrix and the actually measured temperature of the thinner.

In the recycling feed apparatus of the present invention, in addition to the controller for controlling the operation of the apparatus as a whole, there may also be provided a controller (not shown) having an operation function for controlling the feed of the thinner raw solution on the basis of the measurement of the above first concentration meter (5) as well as controlling the feed of the thinner raw solution and the feed of the diluting thinner on the basis of the measurement of the second concentration meter (8). Such a controller includes an input unit for converting signals supplied from respective measuring equipments to digital signals, an arithmetic processing unit such as program controller or computer, and a output unit for converting control signals supplied from the arithmetic processing unit to analog signals.

In the recycling feed apparatus of the present invention, the used thinner discharged from the coating treatment process (9) is recovered into the recovered solution storage tank (21) through the flow path (90). Next, the thus recovered thinner in the recovered solution storage tank (21) is fed to the separation membrane (23) by means of the pump (22) to remove a predetermined amount of the impurities such as pigments and resins from the thinner by passing through the separation membrane (23). The thinner thus purified by the separation membrane (23) is fed to the purified solution storage tank (24) through the flow path (98), whereas the thinner unpassed through the separation membrane (23) which contains the impurities with a high concentration is recirculated to the recovered solution storage tank (21) through the flow path (99).

The purified thinner stored in the recovered solution storage tank (24) of the recovered solution purification mechanism (2) is fed to the constant temperature vessel (27) to adjust the temperature of the thinner to a predetermined value, and then fed to the feed storage tank (1) through the flow paths (91) and (94). In this case, the concentration of the impurities such as pigments and resins in the purified thinner is measured by the first concentration meter (5) disposed on the flow path (91). As a result, when the concentration of the impurities as measured by the first concentration meter (5) is higher than the adequate concentration range or when the concentration of the impurities exceeds an upper limit thereof, the thinner raw solution stored in the raw solution storage tank (31) is fed to the feed storage tank (1) through the flow paths (93) and (94).

In the case where the thinner raw solution is fed to the feed storage tank (1), the thinner raw solution is mixed with the purified thinner in the mixer (4) disposed at the rear stage of the flow paths (91) and (93). In the feed storage tank (1), the thinner stored therein is stirred by the stirring means constituted of the pump (71) and the circulating flow path (96) so as to cause the thinner to exhibit a more uniform concentration. Meanwhile, when the amount of the thinner circulated though the system exceeds an allowable level by feeding the thinner raw solution, the feed of the thinner from the purified solution storage tank (24), i.e., the feed of the thinner from the constant temperature vessel (27) is stopped, and at the same time, the thinner is discharged through the flow path (99b) branched from the flow path (99).

As described above, in the recycling feed apparatus of the present invention, after the resin components are removed from the recovered thinner by the separation membrane (23) of the recovered solution purification mechanism (2), the thus purified thinner is circulated through the system. Therefore, it is possible to enhance a recovery rate (recycling percentage) of the thinner and thereby reduce costs required for the coating treatment process (9). Further, the enhanced recovery rate of the thinner leads to reduction of adverse influence on environments. Furthermore, in the case where the separation membrane (23) of the recovered solution purification mechanism (2) is constituted of a ceramic membrane, such a membrane is excellent in durability and repeatedly usable by cleaning, resulting in reduction of running costs.

Besides, in the recycling feed apparatus of the present invention, upon measuring the concentration of the impurities such as pigments and resins in the purified thinner by the first concentration meter (5), the solution is maintained at a predetermined temperature, and as the first concentration meter (5), there is used a concentration meter capable of not only measuring at least one characteristic value selected from an ultrasonic propagation speed, an electromagnetic conductivity and an absorbance but also, at the same time, measuring the concentration of the impurities on the basis of the specific relationship (matrix) between the concentration of the impurities and the measured characteristic value which is previously prepared by measuring these values. Therefore, the concentration of the impurities in the purified thinner can be more accurately detected, whereby the concentration of the impurities in the feed storage tank (1) can be surely controlled to an adequate range.

Further, in the recycling feed apparatus of the present invention, the temperature of the thinner in the feed storage tank (1) which has been once controlled in concentration of the impurities therein is adjusted to a predetermined value, and then the concentration of the impurities such as pigments and resins in thinner is measured again by the second concentration meter (8) of the same type as the first concentration meter (5) at a high accuracy, thereby enabling fine control of the concentration of the impurities in the thinner. In addition, at this time, using the controller having a specific operation function, the amount of the thinner raw solution or the diluting thinner fed is controlled by the above asymptotic method so as to gradually approach to the target concentration value. Therefore, the concentration of the impurities such as pigments and resins in the thinner stored in the feed storage tank (1) can be more surely controlled within an adequate range, i.e., can be controlled with a still higher accuracy. As a result, according to the feed apparatus of the present invention, the thinner whose concentration is fully controlled at a much higher accuracy can be fed to the coating treatment process (9).

Meanwhile, in the recycling feed apparatus of the present invention, in place of the diluting thinner feed mechanism for feeding the diluting thinner to the feed storage tank (1), there may be used a prepared thinner feed mechanism for temporarily storing the thinner recovered from the coating treatment process (9) and purified by the separation membrane (23) so as to control the concentration of the impurities therein to a predetermined value, i.e., the thinner whose concentration is previously controlled to the concentration to be fed, and then feeding the thus prepared thinner to the coating treatment process (1). The feed of the prepared thinner by the prepared thinner feed mechanism may be controlled on the basis of the concentration detected by the second concentration meter (8). Also, in the recycling feed apparatus of the present invention, the feed storage tank (1) or the feed storage tank (1) equipped with the stirring means as well as the pump (12) and the flow path (97) may be provided as a unit disposed on the side of the coating treatment process (9).

What is claimed is:

1. A recycling feed apparatus for thinner in which a thinner containing impurities is recovered from a coating treatment process, purified and then recycled to the coating treatment process, said apparatus comprising:
a feed storage tank for storing the thinner to be fed to the coating treatment process,
a recovered solution purification mechanism for purifying the recovered thinner, controlling a temperature of the thinner to a predetermined value, and feeding the thus temperature-controlled thinner to the feed storage tank,
a raw solution feed mechanism for feeding a fresh thinner raw solution to the feed storage tank and
a first concentration meter for detecting a concentration of the impurities in the thinner controlled to the predetermined temperature which is fed by the recovered solution purification mechanism;
said recovered solution purification mechanism being provided with a separation membrane for separating and removing the impurities from the recovered thinner;
said first concentration meter being capable of measuring at least one characteristic value selected from an ultrasonic propagation speed through the thinner, an electromagnetic conductivity or absorbance of the thinner, and detecting the concentration of the impurities in the thinner on the basis of a relationship between the concentration of the impurities and the characteristic value which is previously prepared by measuring these values at a predetermined temperature and a predetermined concentration, and
feed of the purified thinner by the recovered solution purification mechanism and feed of the thinner raw solution by the raw solution feed mechanism being controlled on the basis of the concentration detected by the first concentration meter.

2. A recycling feed apparatus for thinner according to claim 1, wherein said apparatus further comprises:
a dilute feed mechanism for feeding a diluting thinner to the feed storage tank or a prepared thinner feed mechanism for feeding a prepared thinner controlled to a predetermined concentration to the feed storage tank,
a second temperature control means for controlling a temperature of the thinner in the feed storage tank to a predetermined value and
a second concentration meter for detecting the concentration of the impurities in the feed storage tank;
said second concentration meter is of the same type as the first concentration meter, and
feed of the thinner raw solution by the raw solution feed mechanism, and feed of the diluting thinner by the dilute feed mechanism or feed of the prepared thinner by the prepared thinner feed mechanism are controlled on the basis of the concentration detected by the second concentration meter.

3. A recycling feed apparatus for thinner according to claim 2, wherein said second temperature control means is provided with a temperature sensor for detecting a temperature of the thinner, and said second concentration meter has a function for executing a correction operation on the basis of the temperature of the thinner detected by the temperature sensor of the second temperature control means upon detecting the concentration of the impurities in the thinner in the feed storage tank.

4. A recycling feed apparatus for thinner according to claim 1, wherein said separation membrane of the recovered solution purification mechanism is a ceramic membrane.

5. A recycling feed apparatus for thinner according to claim 2, wherein said separation membrane of the recovered solution purification mechanism is a ceramic membrane.

6. A recycling feed apparatus for thinner according to claim 3, wherein said separation membrane of the recovered solution purification mechanism is a ceramic membrane.
